(19) United States
(12) Patent Application Publication
(10) Pub. No.: US 2011/0134631 A1
(43) Pub. Date: Jun. 9, 2011

(54) Solar powered apparatus for illuminating signs

(76) Inventor: Craig Webb, Grover Beach, CA (US)

(21) Appl. No.: 11/525,560

(22) Filed: Sep. 21, 2006

(51) Int. Cl. F21L 4/08

(52) U.S. Cl. 362/183

(57) ABSTRACT

A solar powered apparatus for illuminating a sign attached to a sign post comprising: a photovoltaic cell, a light emitter, and a battery pack, the photovoltaic cell is affixed to the sign post such that the photovoltaic cell is exposed to sunlight, the battery pack is in communication with the photovoltaic cell, and the battery pack is in communication with the light emitter.

### FIELD OF THE INVENTION

The present invention relates to the marketing industry and pertains more specifically to an apparatus for advertising.

### BACKGROUND OF THE INVENTION

One of the predominant means of advertising is through physical signs placed upon real estate as opposed to internet marketing, print advertising, radio, television, etc. Many advantages inhere with “brick and mortar” advertising placed upon real estate. One advantage is location. If the location of the advertisement attracts a desirable demographic, the physical sign may prove to be very cost effective. Another advantage may be price. Typically, physical signs for use in advertising is less expensive than the other traditional forms and methods of advertising. And another advantage may be content. Oftentimes, traditional forms of media advertising is limiting in the amount and types of content which are to be displayed. With physical signs a person may have more flexibility in terms of content.

However, as opposed to other traditional mediums of advertising, physical signs face a natural problem: lack of natural sunlight in the evening. Obviously, a physical sign without a means for illumination will go unnoticed by passersby. This can become problematic during winter months when the days are shorter. And this problem may be compounded by the fact that your target demographic are those who put in long hours at work and do not come home until after dusk. For this reason, the physical sign may only be effective during daylight hours. Therefore, without a means for illumination, the effectiveness of a sign may lose about a third to a half of its marketing potential due solely to the availability of sunlight.

However, one way to overcome this problem is through use of electric powered illumination systems. Unfortunately, this solution does not come without its difficulties. One problem which inheres with using electric powered illumination means is that it is often accompanied with a long, bulky, and cumbersome cord. Several problems are accompanied through use of such a cord. For instance, oftentimes there is no readily available power source nearby. Another potential danger is if the cord traverses through areas prone to flooding or large amounts of water a potential hazard may be created. Additionally, the electricity to power these signs can cost a substantial amount of money.

Therefore, what is clearly needed in the art is a solar powered illumination apparatus and system which is simple in design. The system should begin illumination upon dusk by a light meter. By using a light meter the system will not require re-setting due to the time of the year or the spring/fall time changes.

### SUMMARY OF THE INVENTION

It is an object of the present invention to provide a system and an apparatus for use in illuminating various signs using solar powered means. Such an apparatus and system would work without cords or awkward external devices.

It is an object of the present invention to provide a system and an apparatus which is environmentally and eco-friendly by harnessing energy from the sun rather than on standard electricity which is derived principally from fossil fuels. Such a system which harnesses energy from the sun rather than from batteries, fossil fuels, etc. is more desirable due to the limited supplies thereof and with the deleterious effects such energy supplies bring to the environment.

It is an object of the present invention to provide a system and an apparatus for use in decreasing energy costs in illuminating signs. Such benefits would redound to the user because no external energy source would be required in illuminating the signs.

It is an object of the present invention to provide a system and an apparatus for use with a panoply of different signs. The present invention is comprised in some embodiments of an adapter. This adapter enables the present invention to be used with several different types of signs.

It is an object of the present invention to increase the visibility, marketability, exposure, demographics, and overall effectiveness of various signs by illuminating the signs during night-time hours. By illuminating during night-time hours, the product, real estate or services which the sign is marketing may be read by twice as many potential clients or customers as signs which are only visible during daylight hours.

It is an object of the present invention to be affixed to glass windows through use of suction cups. This embodiment would be advantageous because there will be no unsightly wires or chords attached to the sign thereby contributing to its aesthetics. Furthermore, this embodiment would be advantageous inasmuch as it would enable a person to place the illuminated sign in places where no electrical outlet is nearby.

### BRIEF DESCRIPTION OF THE DRAWING FIGURES

FIG. 1a is a perspective view of a preferred embodiment of the present invention.

FIG. 1b is a perspective view of a preferred embodiment of the present invention.

FIG. 2a is a perspective view of a preferred embodiment of the present invention.

FIG. 2b is a perspective view of a preferred embodiment of the present invention.

FIG. 3a is a perspective view of a preferred embodiment of the present invention.

FIG. 3b is a perspective view of a preferred embodiment of the present invention.

FIG. 3c is an isometric view of a preferred embodiment of the present invention.

FIG. 3d is an isometric view of a preferred embodiment of the present invention.

FIG. 4a is a perspective view of a preferred embodiment of the present invention.

FIG. 4b is a perspective view of a preferred embodiment of the present invention.

FIG. 4c is a perspective view of a preferred embodiment of the present invention.

FIG. 4d is an isometric view of a preferred embodiment of the present invention.

FIG. 4e is an isometric view of a preferred embodiment of the present invention.

FIG. 5a is a perspective view of a preferred embodiment of the present invention.

FIG. 5b is a perspective view of a preferred embodiment of the present invention.

FIG. 5c is an isometric view of a preferred embodiment of the present invention.

### DESCRIPTION OF PREFERRED EMBODIMENTS

According to a preferred embodiment of the present invention, a unique system and accompanying apparatus is used to hold a sign displaying indicia and for the illumination thereof. The means of supplying energy for the illumination is through a solar panel. The present invention is described in enabling detail below.

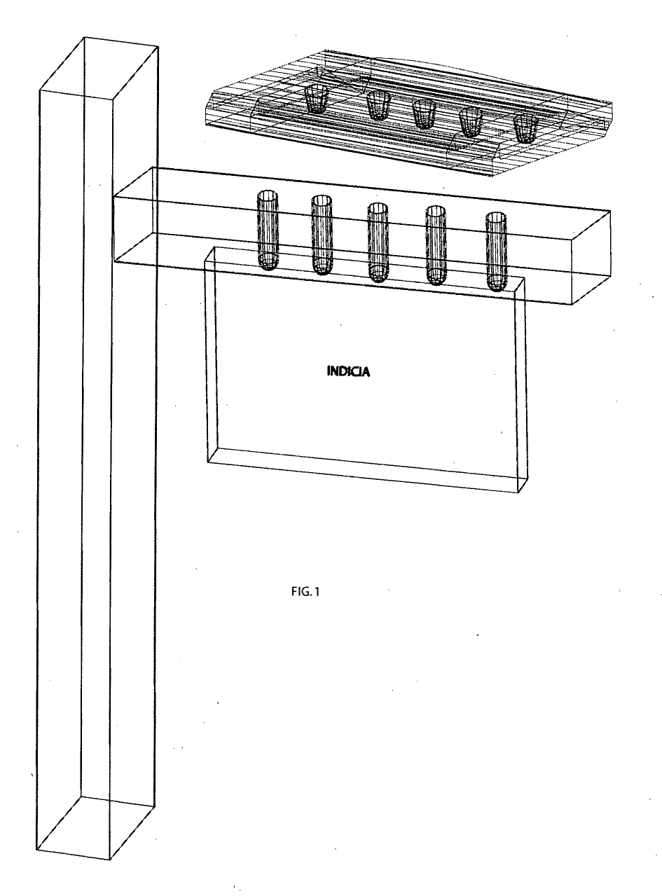

FIG. 1a is a perspective view of a preferred embodiment of the present invention. Solar illuminator 100 (hereafter SI 100) is comprised of a post 101, a photovoltaic cell 102, a circuit board 103, a plurality of light wells 104, a battery pack 105, a solar compartment 106, a plurality of light emitters 107, a power compartment 108, a sign 109, and a photodetector 110.

The post 101 in a preferred embodiment is the frame upon which the SI 100 is placed upon. Post 101 in some embodiments may embody a rectangular shaped member. It should be pointed out here that the present invention may be adapted for use with a panoply of different signs and their attendant frames upon which they hang. In this particular embodiment an end user will have to drill orifices to form the light wells 104. The light wells 104 will house the light emitters 107. It will also be noted here that the mentioning of post 101 along with its corresponding reference numeral is not intended to suggest that the post is part of the invention. The mentioning of post along with its corresponding reference numeral is solely for illustrative purposes.

In this particular embodiment an end-user will bore or drill holes into the post 101 as illustrated in FIG. 1b in order to house the light emitters 107 thereby creating the light wells 104. FIG. 1b illustrates that in this preferred embodiment, the light wells 104 are oriented from top to bottom. In other embodiments, the orientation of the light well may vary. Furthermore, the number of light wells 104 will be determined by the number of light emitters 107 which will be used. The number of light emitters 107 (it is possible that there may only be one light emitter in a preferred embodiment) will vary. The number of light emitters 107 will be dependent upon factors such as aesthetics, power requirements and limitations, the size of the sign 109, economic factors, etc. Moreover, the type of light emitters is inconsequential because there abound a vast array of such light emitters which are equally expedient for the functions required. One skilled in the art will be able to discern which particular light emitter will be most expedient for the particular size and type of sign. For this reason, the scope of the present invention is not necessarily limited by the type of light emitters used.

Power compartment 108 houses the battery pack 105, the circuit board 103 and other attendant components. Battery pack 105 comprises a plurality of re-chargeable batteries. Battery pack is in electrical communication with the photovoltaic cell 102. As battery pack progressively depletes its energy during normal operation, the battery pack 105 is re-charged by the photovoltaic cell 102. Moreover, some preferred embodiments may also incorporate a converter for the purpose of increasing or decreasing voltage as well as converting electricity from DC to AC.

The specific type of battery pack 105 along with its constituent re-chargeable batteries is of no consequence inasmuch as it is expedient for the energy demands of the present invention. Moreover, the number of re-chargeable batteries will depend upon the energy needs of the present invention. And in some preferred embodiments, the present invention may further comprise a reserve battery pack. Reserve battery pack may be provided in the event when the battery pack along with its constituent re-chargeable batteries, eventually wear out.

The solar compartment 106 holds the photovoltaic cell 102 and is placed on top of the housing member 101. The solar compartment 106 in some preferred embodiments is shaped to have flanges on the sides. The distance between the flanges should roughly correspond to the width of the post 101 to which it will be placed. On the upper side of the solar compartment 106 is a recess used to retain the photovoltaic cell 102. The shape, and dimensions of the recess should correspond to the outline, shape, and thickness of the photovoltaic cell 102 in order to properly retain the photovoltaic cell 102.

In some preferred embodiments the solar compartment 106 is composed of a plastic material. It is desirable to use a high impact plastic THK to compose the solar compartment 106. However, there abound a panoply of suitable materials. Fungible materials may include metal, rubber, cardboard, polycarbonate materials, glass, etc. The type of material will be dictated primarily by factors such as cost, durability, size, shape, aesthetics, etc. Neither the shape, materials of composition, or size of the cell retainer are meant to be limiting to the scope of the present invention.

Photodetector 110 is also incorporated into the present invention. Photodetector 110 may be incorporated into the photovoltaic cell as illustrated in FIG. 1a. The purpose of the photodetector 116 is to actuate the apparatus to either turn on the light emitters 107 or to turn them off Obviously, there is no need to illuminate the sign during daylight hours. In fact, by illuminating the sign during daylight hours the light emitters may wear out a lot sooner. In addition, the power required to power the light emitters 107 will make re-charging the battery pack 105 more difficult.

For purposes of the present invention there is no particular type of photodetector 110 which is required. There abound a panoply of various photodetectors 110 which may all prove equally expedient to the present invention.

Also incorporated in the present embodiment is a photovoltaic cell 102. Photovoltaic cell 102 harnesses the energy from the sun to power all of the embodiments of the present invention. Since there abound a panoply of different photovoltaic cells which may be used with the present invention, no particular photovoltaic cell is needed provided it can be incorporated into the present invention and meets the specifications for the objectives and functions of the present invention. For this reason, the scope of the present invention is not necessarily limited by any type of photovoltaic cell.

FIG. 1e illustrates a schematic for a preferred embodiment of the present invention. The switch 200 closes the circuit and connects the battery pack 105 with the circuit board 103. The photodetector 110 controls the switch 200. Since there abound a panoply of ways one may devise the circuit board 103 to achieve the objectives of the present invention no more detail will be made herein. A person skilled in the art will readily understand how to devise the electrical system.

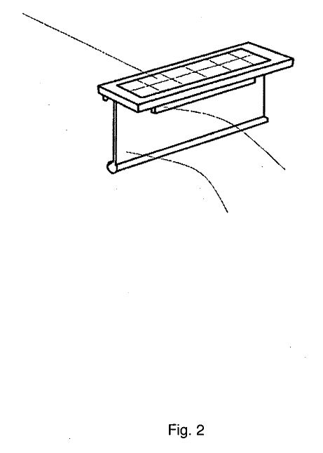

FIGS. 2a and 2b illustrate another preferred embodiment of the present invention. This embodiment will be referred to as the attached S1200. In this embodiment the system does not require the post 202 to be drilled or bored into for light wells. Instead the light emitter is affixed externally to the underside of the post 202.

The attached S1200 comprises a photovoltaic cell 201, a post 202, a light apparatus 203, a photodetector 205, a solar compartment 214, a wire 212, a circuitboard 208, a battery pack 213, a hole 210, a clip 207, a clip port 209, a power compartment 211, a plug 215. The attached S1200 is similar in function to the SSI 100. The photovoltaic cell 201 is housed within the solar compartment. Affixed to the photovoltaic cell is the photodetector. And on one distal end of the solar compartment is a clip which is sized to mate with a clip port found on the distal end of the power compartment.

Housed within the power compartment 211 is a battery pack, circuitboard , and a hole. The hole is used for receiving light wire which is in communication with the light apparatus. In this preferred embodiment the light apparatus is a cold cathode fluorescent lamp (hereafter CCFL). However, other equally expedient lighting means may also be used. The type of light apparatus is not meant to be construed to be limiting to only CCFL's.

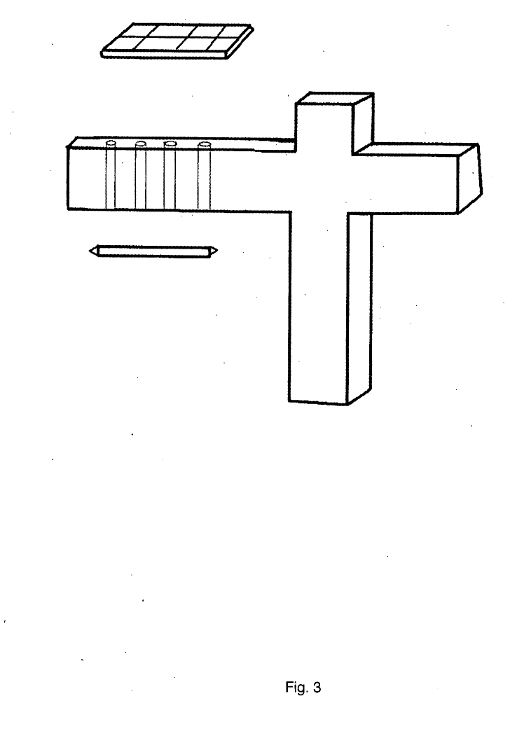

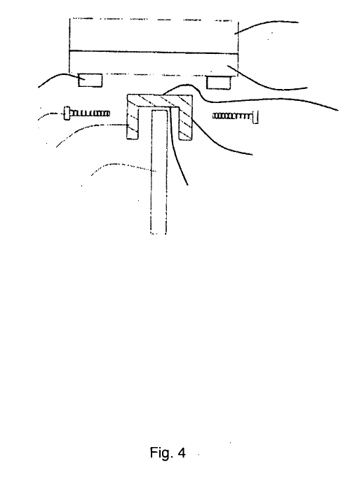

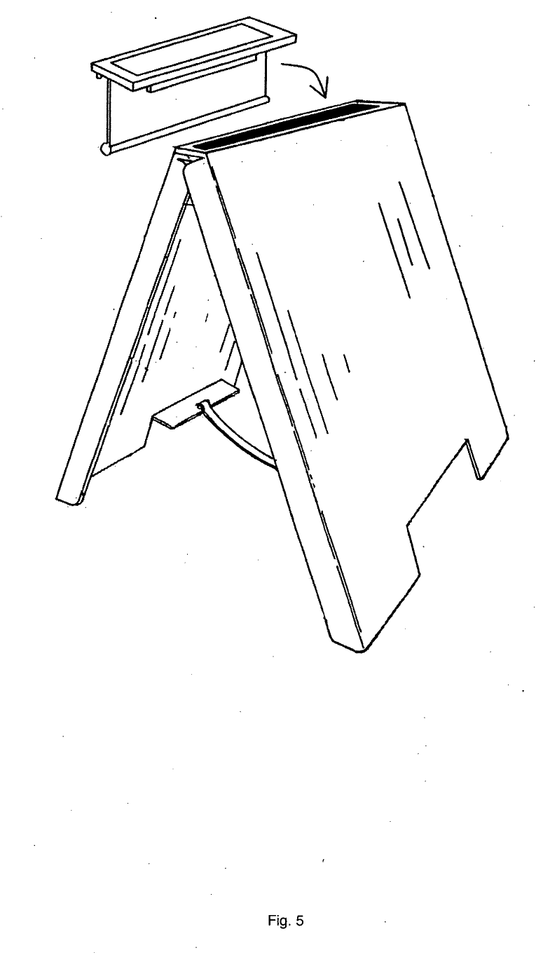

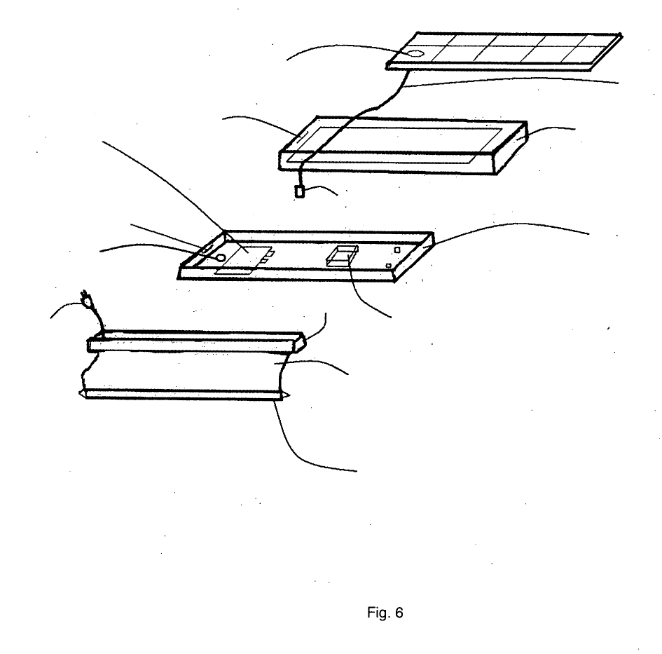

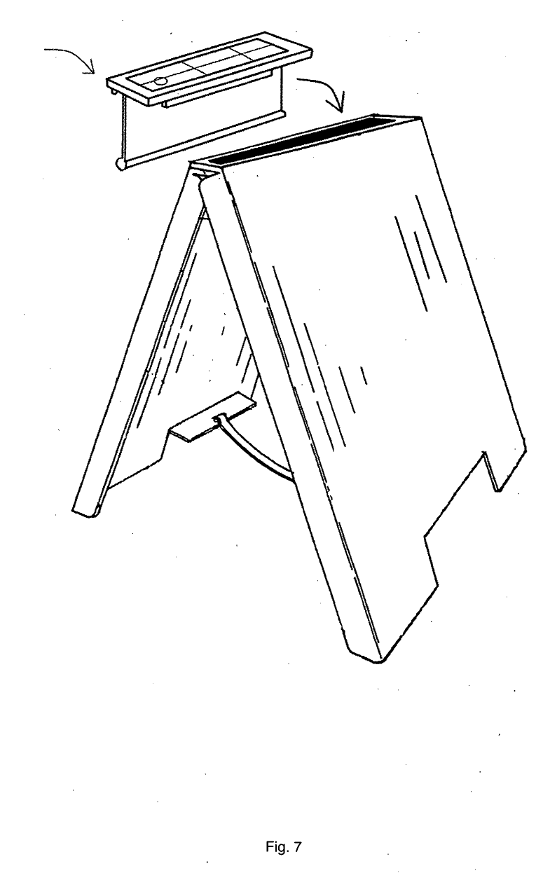

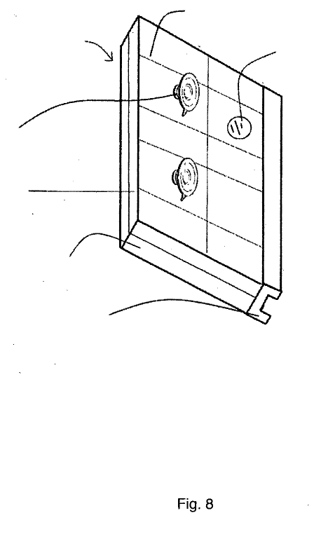

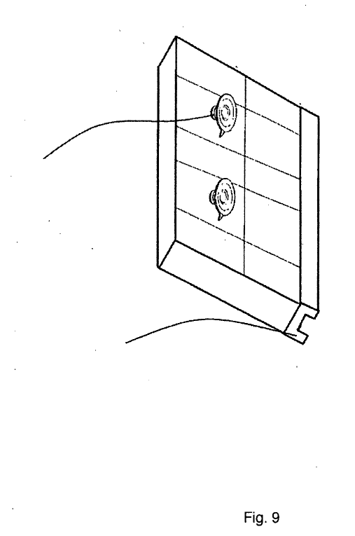

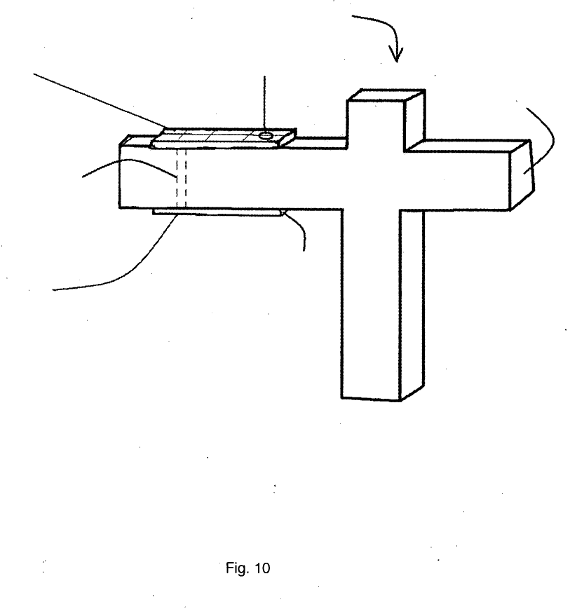

FIGS. 3a-3c illustrate components which are meant to be used for “sandwich boards” and other signs. FIGS. 3b-3c show primarily an adapter for use with some of the preferred embodiments of the present invention. Adapter 300 comprises an interface member 301, fastening members 307, a top side 308, lateral sides 302, a bottom side 303, sign orifices 306, interface orifices 305, and a sign 304.

The adapter 300 is attached to the underside of the power compartment 310 as well as the CCFL 311. Solar compartment 309 is affixed to the top of the power compartment. They are both sized to mate with each other. The interface orifices 305 enable fastening with the underside of the power compartment. The fastening members 307 are used to hold in place the sign 304. The fastening members 307 are placed through the sign orifices 306. However, it should be pointed out here that in some other preferred embodiments there may be only one sign orifice and only one attendant fastening member 307. And in some preferred embodiment the fastening member 307 is a screw.

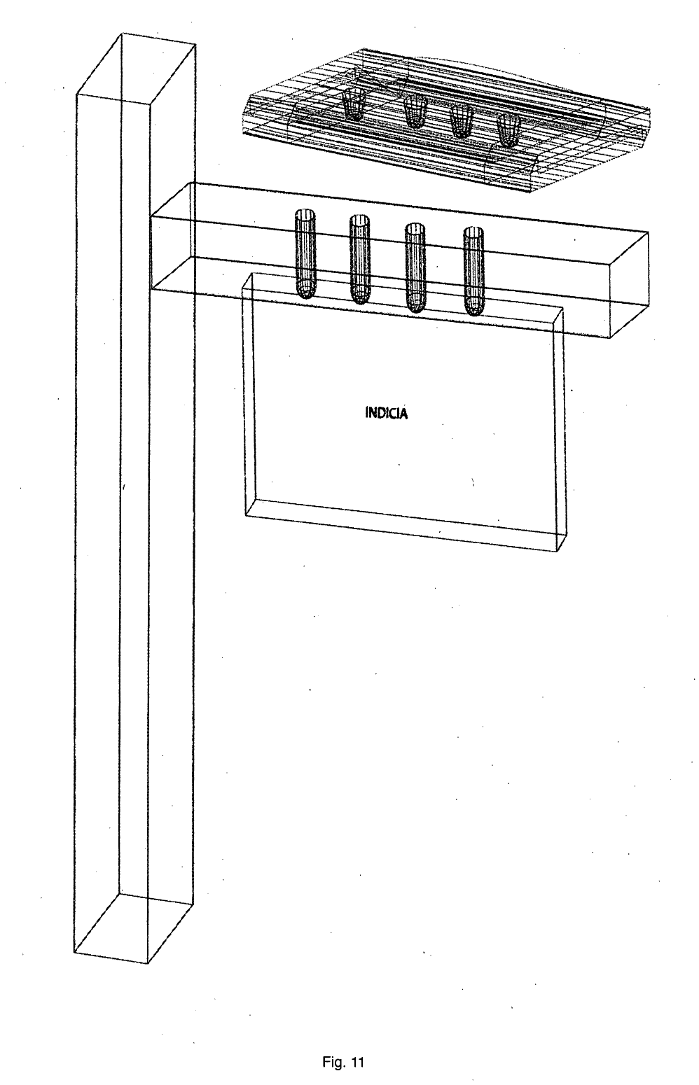

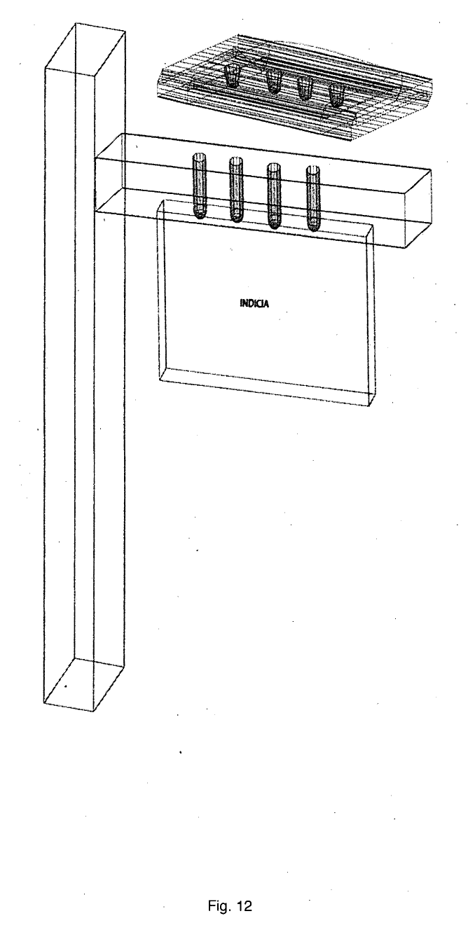

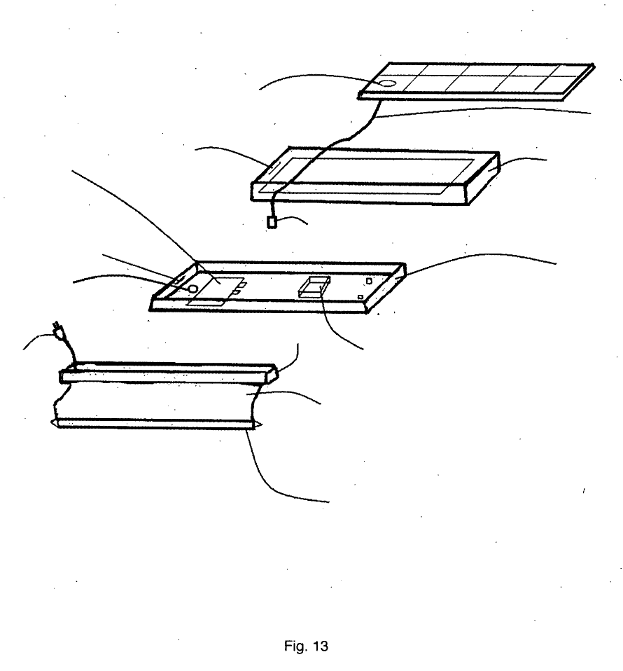

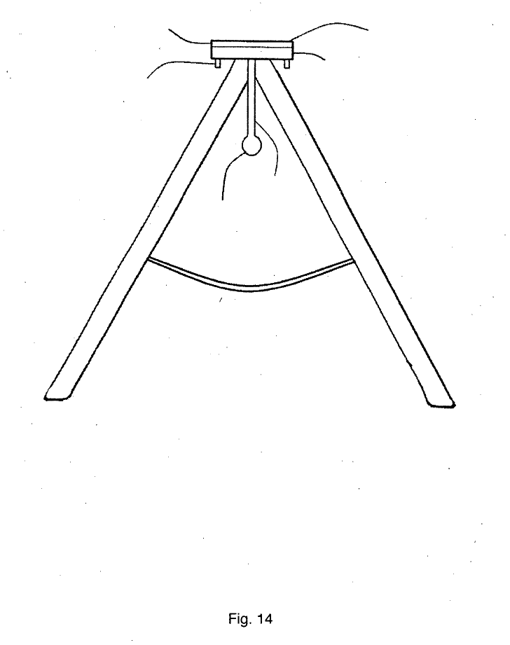

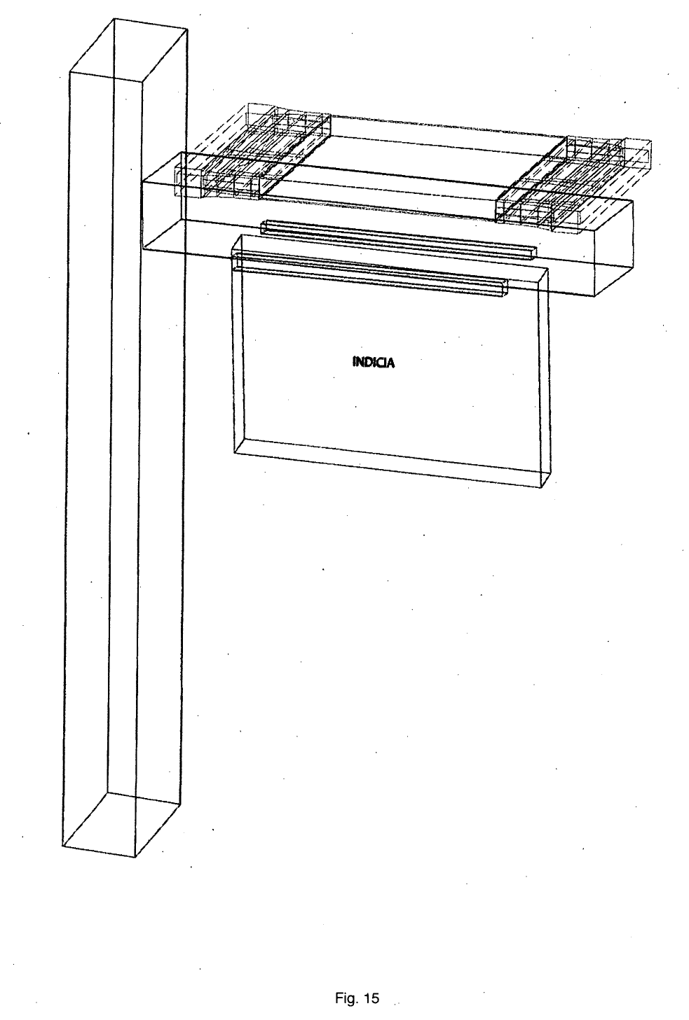

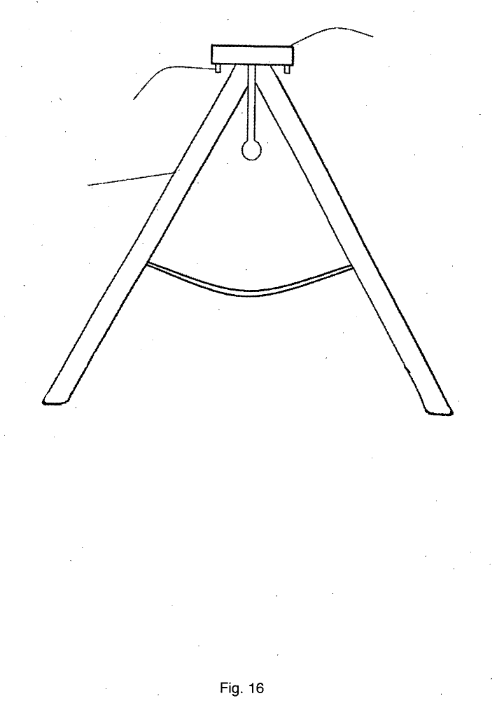

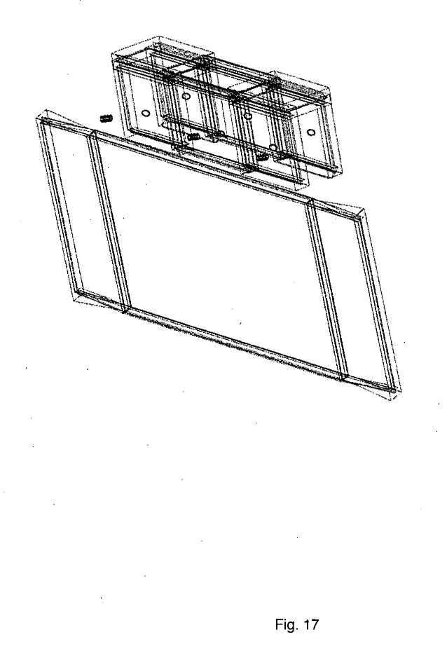

FIGS. 4a-4e illustrate another preferred embodiment of the present invention. This particular embodiment is adapted for use with “A” signs or “sandwich boards”. This particular embodiment shall hereafter be referred to as A S1400. A S1400 comprises a photovoltaic cell 401, a photodetector 402 and at least two light emitters 404 and a stabilizer 403 and a rounded edge 405. The frame upon which it is placed upon is the A frame 407. A S1400 is simply placed into the space as shown in FIG. 4a. Stabilizer 402 helps prevent A S1400 from falling off or from instability.

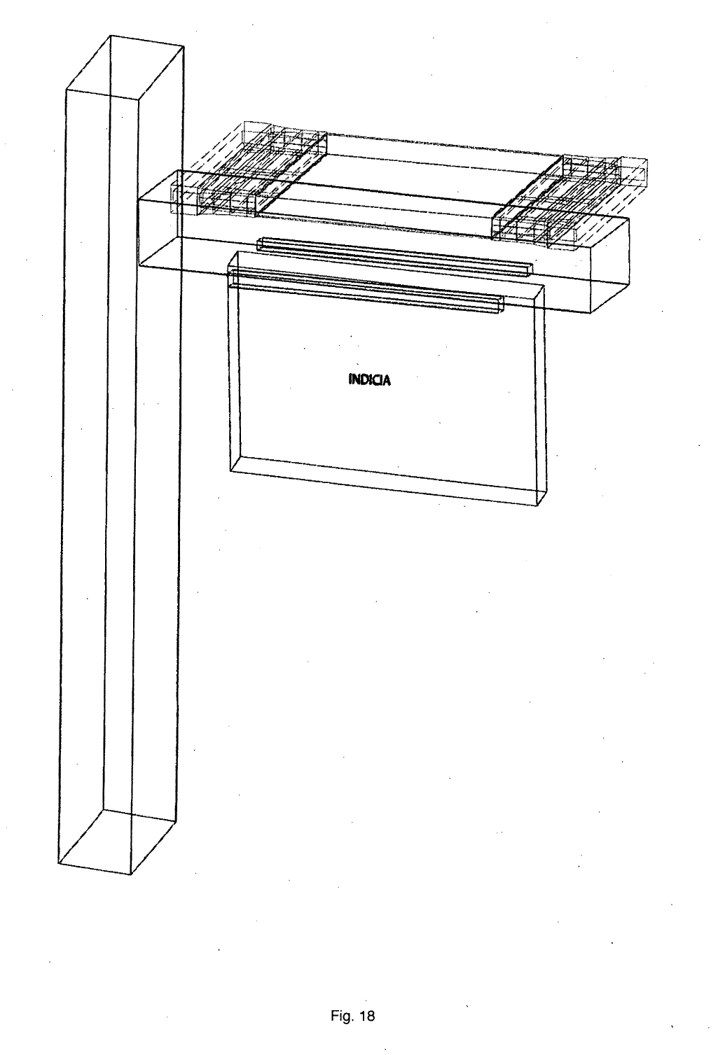

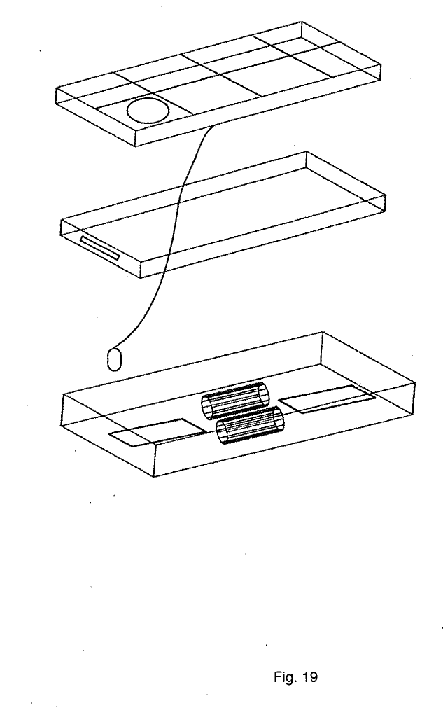

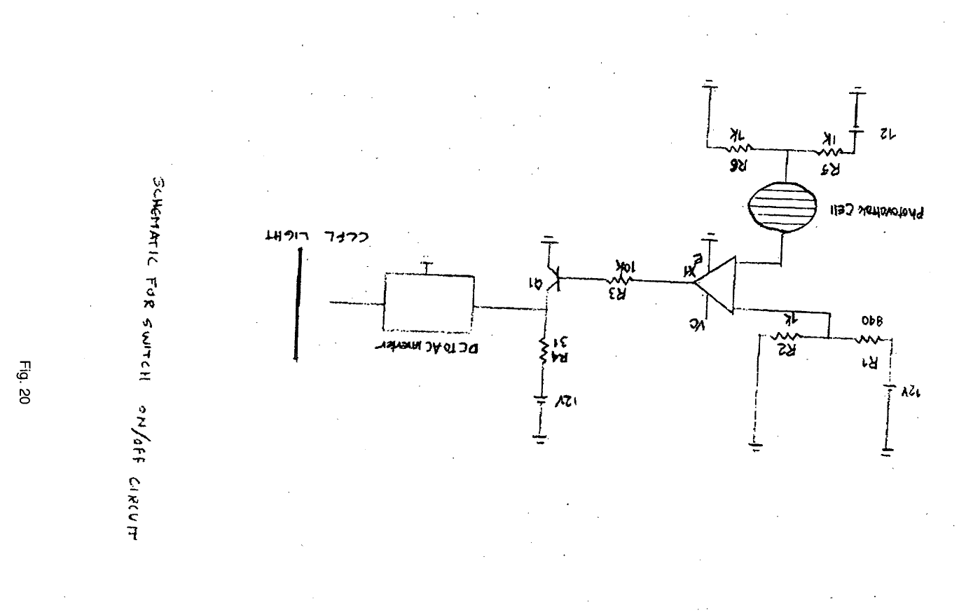

FIGS. 5a-5c illustrate a preferred embodiment for use in affixing to windows through use of suction cups. Window SI comprises a photovoltaic cell 506, at least one suction cup 501, at least one light apparatus 502, a power compartment 511, a solar compartment 514, a photodetector 505, a wire 512, a solar clip 507, a power clip, 509, a plug 515, a circuitboard 508, a power orifice 510, an adapter plug 519, a light emitter 518, and a battery pack 513.

The components listed above are assembled and function in the same manner as the aforementioned embodiments and will not be explained again. One skilled in the art will be able to readily understand how to make and use this embodiment.

The window S1500 is affixed to the glass by pressing the suction cup 501 against the window. The photovoltaic cell 506 should be facing the sun in order to generate energy.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A solar powered apparatus for illuminating a sign attached to a sign post comprising: a photovoltaic cell, at least one light emitter, and a battery pack, the photovoltaic cell is disposed upon the sign post such that the photovoltaic cell is exposed to sunlight, the battery pack is in communication with the photovoltaic cell, and the battery pack is in communication with the light emitter.

2. The solar powered apparatus of claim 1 further comprising a photodetector, the photodetector for use in turning on the solar power apparatus during dark hours and for turning off the solar power apparatus during daylight hours.

3. The solar powered apparatus of claim 2 further comprising a circuitboard, the circuitboard for use in connecting the battery pack, photovoltaic cell, light emitter, and the photodetector.

4. The solar powered apparatus of claim 3 further comprising a solar compartment, the solar compartment for use in housing the photovoltaic cell and the photodetector.

5. The solar powered apparatus of claim 4 further comprising a power compartment, the power compartment for use in housing the circuitboard, and the battery pack.

6. The solar powered apparatus of claim 5 wherein the power compartment is sized to fit the solar compartment.

7. The solar powered apparatus of claim 6 wherein the light emitter is a cold cathode fluorescent lamp.

8. The solar powered apparatus of claim 7 further comprising a suction cup; the suction cup is affixed to the photovoltaic cell and is used for affixing to a glass surface.

9. The solar powered apparatus of claim 7 further comprising an adapter; the adapter comprising an interface member, fastening members, a top side, lateral sides, a bottom side, sign orifices, interface orifices, and a sign, the adapter is attached to the bottom side of the power compartment ,the interface orifices are located on the top side of interface member and enable fastening with the underside of the power compartment, the fastening members are used to hold the sign ,the fastening members are placed through the sign orifices.

10. The adapter of claim 9 wherein the fastening member is a screw.

11. A solar powered apparatus for illuminating a sign and adaptable for use with sandwich boards comprising: : a photovoltaic cell, at least one light emitter, and a battery pack, an adapter; the adapter comprising an interface member, fastening members, a top side, lateral sides, a bottom side, sign orifices, interface orifices, and a sign, the adapter is attached to the bottom side of the power compartment ,the interface orifices are located on the top side of interface member and enable fastening with the underside of the power compartment, the fastening members are used to hold the sign ,the fastening members are placed through the sign orifices.

12. The solar powered apparatus of claim 11 further comprising a power compartment and a solar compartment; the power compartment comprising a circuitboard and a battery pack; the battery pack is in communication with the photovoltaic cell; the solar compartment houses the photovoltaic cell; the power compartment is sized to fit with the solar compartment.

13. The solar powered apparatus of claim 12 further comprising a photodetector.

14. The solar powered apparatus of claim 13 wherein the light emitter is a cold cathode fluorescent lamp.

15. The solar powered apparatus of claim 14 wherein the photodetector turns the cold cathode fluorescent lamp off during daylight hours.

16. The solar powered apparatus of claim 15 further comprising a stabilizer, the stabilizer for use in retaining the solar powered apparatus within the sandwich board.

17. The solar powered apparatus of claim 16 further comprising a circuitboard, the circuitboard for use in connecting the battery pack, photovoltaic cell, light emitter, and the photodetector.

18. The solar powered apparatus of claim 17 wherein the fastening member is a screw.

19. The solar powered apparatus of claim 18 wherein the solar powered apparatus comprises two cold cathode fluorescent lamps.

20. A solar powered apparatus for illuminating a sign attached to a sign post comprising: a photovoltaic cell, at least one light emitter, and a battery pack, the photovoltaic cell is affixed to the sign post such that the photovoltaic cell is exposed to sunlight, the battery pack is in communication with the photovoltaic cell, and the battery pack is in communication with the light emitter; a photodetector, the photodetector for use in turning on the solar power apparatus during dark hours and for turning off the solar power apparatus during daylight hours; a circuitboard, the circuitboard for use in connecting the battery pack, photovoltaic cell, light emitter, and the photodetector. a solar compartment, the solar compartment for use in housing the photovoltaic cell and the photodetector. a power compartment, the power compartment for use in housing the circuitboard, and the battery pack, a solar compartment, the solar compartment for use in housing the photovoltaic cell and the photodetector, the solar compartment is sized to fit and mate with the power compartment; an adapter; the adapter comprising an interface member, fastening members, a top side, lateral sides, a bottom side, sign orifices, interface orifices, and a sign, the adapter is attached to the bottom side of the power compartment ,the interface orifices are located on the top side of interface member and enable fastening with the underside of the power compartment, the fastening members are used to hold the sign ,the fastening members are placed through the sign orifices.
